(19) United States
(12) Patent Application Publication
(10) Pub. No.: US 2011/0084129 A1
(43) Pub. Date: Apr. 14, 2011

(54) Voice Code with Primary and Secondary Digits

(76) Inventor: Elliott Grant, Redwood City, CA (US)

(21) Appl. No.: 12/689,949

(22) Filed: Jan. 19, 2010

Related U.S. Application Data
(63) Continuation-in-part of application No. 12/576,092, filed on Oct. 8, 2009.

(51) Int. Cl. G06K 19/06; G06F 17/00

(52) U.S. Cl. 235/375; 235/494

(57) ABSTRACT

A Produce Traceability Initiative compliant case label includes the GTIN, the lot code, an optional date, and a short numeric voice code. The voice code is derived from the GTIN and the lot code and the date when present by an algorithm. Cases of goods that include these case labels are shipped by the source of goods to a distribution center for redistribution to retailers. The distribution center records the GTIN, lot code and optional date upon receipt. The distribution center uses the same algorithm to generate voice codes, and then uses the voice codes to direct pickers to fill orders from specific lots using automated pick systems. Pickers use the voice codes to find the intended cases and to confirm that cases from the intended lot were picked, or to indicate a different lot was picked. The distribution center then associates the lot code of the picked lot with the outgoing order.

### CROSS-REFERENCE TO RELATED APPLICATIONS

This application is a Continuation-In-Part of U.S. Non-Provisional Patent application Ser. No. 12/576,092 filed on Oct. 8, 2009 and entitled “Voice Code for Distribution Centers” which is incorporated herein by reference.

### BACKGROUND OF THE INVENTION

1. Field of the Invention

The invention relates generally to the field of product traceability and more particularly to tracking cases through distribution centers.

2. Description of the Prior Art

The Produce Traceability Initiative (PTI) is an initiative designed to improve traceability of produce through the entire supply chain from the source to the point of sale. Compliance with the Initiative requires that each case of goods carry a label that includes a Global Trade Identification Number (GTIN), a lot code, and optional date. Further, the GTIN, lot code and optional date for each case are recorded at each point along the supply chain. The PTI requires the date in those instances where the lot code is not date-specific.

FIG. 1 illustrates a typical supply chain. Each source of goods 100, such as a produce grower, sends pallets 110 of goods to a distribution center 120. Each pallet 110 includes a plurality of cases 130, each case 130 bearing a label (not shown) with the requisite GTIN, lot code and optional date. While the Initiative is an undertaking of the produce industry, it can be seen that sources of goods 100 can just as easily be meat packers, dairies, canners, processed food manufacturers, pharmaceutical makers, and so forth.

To comply with the Initiative, each source of goods 100 records the GTIN, lot code and optional date in a database 140 for each case 130 that is shipped. The GTIN, lot codes and optional dates on a pallet may also be summarized on a pallet label which shows the GTIN, lot code, optional date and quantity of cases on that pallet.

At the distribution center 120 the GTINs, lot codes and optional dates of the received cases 130 are again recorded, this time in a database 150. The distribution center 120 can either scan every case label with a bar code scanner or scan the pallet label with the summary barcode or use some other electronic means to load GTINs, lot codes and optional dates and quantities into their database 150. Next, the pallets 110 are typically moved into a warehouse location awaiting outbound shipping to individual retailer stores or restaurants 160. To fulfill orders, new pallets 170 are assembled with cases 130 from different sources of goods 100. Here, compliance with the Initiative becomes much more burdensome on the distribution centers 120.

A typical distribution center 120 employs a Warehouse Management System (WMS). The WMS tracks the location of each pallet 110 and the number of cases 130 remaining on each. When a retailer 160 submits an order, a picker is directed by the WMS to various locations within the distribution center 120 with instructions for the number of cases to be picked at each. In this way the picker assembles the pallet 170. An exemplary command would be “Station 18, six cases.” In the typical distribution center 120 the picker receives spoken commands from the WMS through a wireless headset and speaks into the headset to communicate confirmation back to the WMS.

Picking orders for retailers 160 in this manner is highly efficient, however, attempts to add a step to the picking process for recording GTINs, lot codes and optional dates of cases 130 as they are picked have proved to be problematic. When pickers have to manually scan every case 130 with a barcode scanner it significantly increases the time it takes to fill orders. In the alternative, pickers can read to the WMS at least a part of the lot code on each picked case. This has not proven to be satisfactory, either. For instance, if the practice is to read the last three characters of each lot code, sometimes two lots on the same pallet 130 will have different lot codes that coincidentally end in the same last three characters and the WMS cannot determine which lot code to associate with the order. Additionally, voice recognition systems tend to have trouble differentiating spoken letters, leading to further sources of error as lot codes can include any alphanumeric character. Moreover, pickers may misread codes or read the GTIN instead of the lot code.

For the lack of a simple workable solution that does not hurt productivity, distribution centers 120 have been reluctant to committing to implementing the Initiative to the extent of recording GTIN, lot code and optional date of cases 130 being distributed to retailers 160. It can be seen, therefore, that there is a need for an efficient way to record the GTIN, lot code and optional date of cases 130 being assembled onto pallets 170 for distribution to retailers 160.

### SUMMARY

The present invention provides a case label that can be affixed to cases by a source of goods. Exemplary case labels comprise a GTIN, lot code and optional date both in a machine-readable format and in a human-readable format. Exemplary case labels also comprise a numeric code, also referred to herein as a voice code, of no more than three digits. The voice code on each case label is generated from the specific GTIN, lot code and optional date on that case label. In various embodiments, the voice code is made more prominent than other codes, for example, by being printed with a larger font size and/or as white numerals on a black background on the case label.

Another exemplary case label also comprises a GTIN, lot code and optional date, provided in a machine-readable format and in a human-readable format, and further comprises a numeric code comprising at least three digits and no more than five digits. At least two of the digits of the numeric code are primary digits, and at least one of the digits of the numeric code are secondary digits. Some embodiments consist of two primary digits and two secondary digits.

As printed on the label, the primary and secondary digits are visually distinguishable, with the primary digits being more prominent so that they are more easily noticed and easier to read. One way in which the numeric code is made prominent is to print white numerals against a colored or black background. The primary digits are printed with a larger font than the secondary digits, in some embodiments, to make the primary digits more prominent than the secondary digits.

The present invention also provides methods for labeling cases at a source of goods. One such exemplary method comprises using an algorithm to generate a voice code of three or less digits from a GTIN and lot code and optional date. The exemplary method can also comprise printing a case label after generating the voice code, where the case label includes each of the GTIN, lot code, an optional date, and voice code. In various embodiments, generating the voice code comprises hashing the GTIN, lot code and optional date and constraining the output with a modulo function. The exemplary method can also comprise affixing the case label to a case, and recording the GTIN, lot code and optional date in a database when the case is shipped.

Another exemplary method for labeling cases comprises generating a numeric code of at least three digits and no more than five digits from a GTIN, lot code and optional date using an algorithm, affixing a label to a case, the label including the GTIN, lot code, optional date, and numeric code, and recording the GTIN, lot code and optional date into a database. The numeric code can be generated, in some embodiments, by hashing the GTIN, lot code and optional date and constraining the output with a modulo function. In some embodiments, the method further comprises printing the label after generating the numeric code.

The present invention further provides methods for utilizing voice codes on case labels in distribution centers to implement efficient tracking of outgoing cases. An exemplary method comprises receiving a pallet of cases, each case having a case label including a GTIN, lot code, optional date, and voice code. The method can further comprise reading the GTIN, lot code and optional date from a case label, for example with a barcode scanner, and recording the GTIN, lot code and optional date in a WMS.

The method can further comprise receiving a pick order for a number of cases of the GTIN and selecting a particular date-specific lot code for that GTIN from which to fill the order. The method additionally comprises generating a voice code from the GTIN and the selected lot code and optional date. The voice code is generated using the same algorithm used to generate the voice code printed on the labels of the cases of the selected lot code. The method can further comprise directing a picker to fill the order, for example, by providing the picker with a location in the distribution center, the number of cases, and the voice code. The picker fills the order with the number of cases having the voice code thereon, and confirms the voice code back to the WMS. The method can further comprise the WMS receiving the confirmation and creating a record in a database of an association between the order and the number of cases of the GTIN, lot code and optional date.

Another exemplary method for utilizing voice codes on case labels comprises reading a GTIN, lot code and optional date from a label, and generating a numeric code of at least three digits and no more than five digits from the GTIN, lot code and optional date using an algorithm, at least two of the digits of the numeric code being primary digits and at least one of the digits of the numeric code being secondary digits. The method further comprises directing a picker to pick the primary digits from a location in a distribution center, receiving a confirmation from the picker, and associating the GTIN, lot code and optional date with an order. In various embodiments, the confirmation comprises the primary digits. Reading the GTIN, lot code and optional date from the label can be performed with a barcode scanner, for example.

Still another exemplary method for utilizing voice codes on case labels also comprises reading a first GTIN and a first lot code and a first optional date from a label, and generating a first numeric code of at least three digits and no more than five digits from the first GTIN and the first lot code and the first optional date using an algorithm, at least two of the digits of the first numeric code being primary digits and at least one of the digits of the first numeric code being secondary digits. In this exemplary embodiment the method further comprises identifying a product to pick, the product being characterized by the first GTIN and the first lot code and the first optional date, and determining a primary digit collision for the product. Here, the primary digit collision is defined between cases of the product at a location in a distribution center bearing a first label including the first numeric code, and cases of the product at the location bearing a second label including a second numeric code. The exemplary method further comprises directing a picker to pick the primary and secondary digits of the first numeric code from the location, and receiving a confirmation from the picker. In various embodiments the confirmation comprises the secondary digits of the first numeric code. Some embodiments further comprise associating the first GTIN and the first lot code and the first optional date with an order.

In some instances, the confirmation comprises digits other than the secondary digits of the first numeric code. This can occur where the cases labeled with the first numeric code are inaccessible but cases of the same product but labeled with a second numeric code are on the same pallet and can be substituted by the picker. In some of these embodiments the method further comprises verifying that the confirmation matches secondary digits of the second numeric code, and associating a second GTIN and a second lot code and a second optional date associated with the second label with an order.

### BRIEF DESCRIPTION OF DRAWINGS

FIG. 1 is a schematic representation of a supply chain of the prior art.

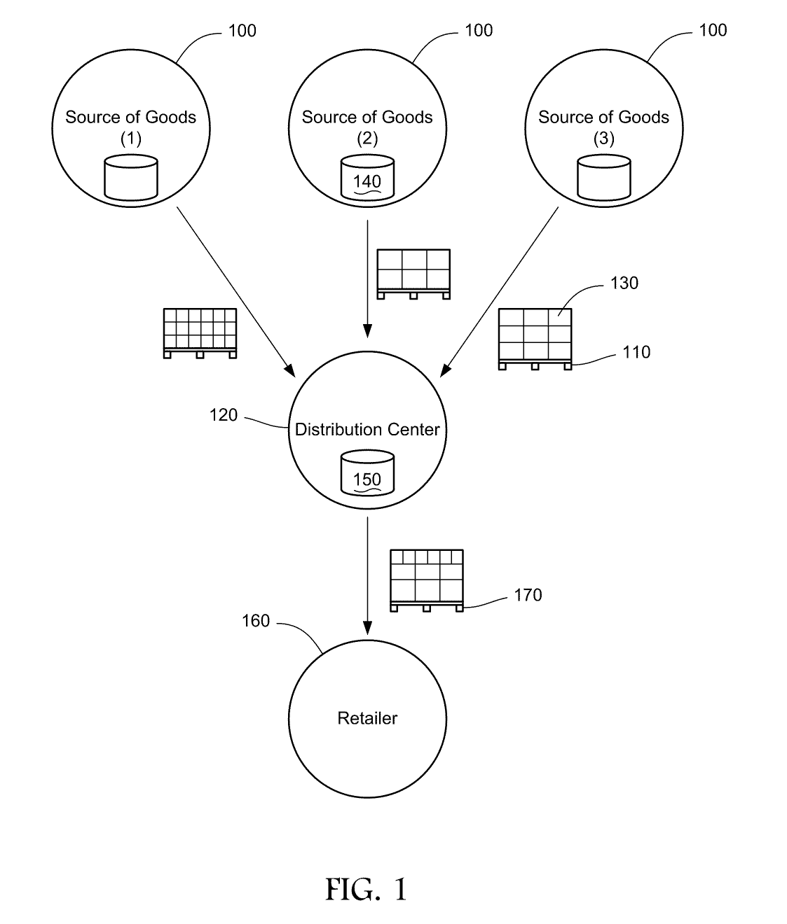

FIG. 2 illustrates a case including a case label according to an exemplary embodiment of the invention.

FIG. 3 is a flowchart representation of a method according to an exemplary embodiment of the invention.

FIG. 4 is a flowchart representation of a method according to another exemplary embodiment of the invention.

FIG. 5 illustrates a case including a case label according to another exemplary embodiment of the invention.

FIG. 6 is a table of exemplary voice codes produced from exemplary pairs of GTIN and lot codes, according to an embodiment of the invention.

FIG. 7 is a flowchart representation of a method according to still another exemplary embodiment of the invention.

### DETAILED DESCRIPTION OF THE INVENTION

The present invention provides labels that comply with the PTI and that also include a prominent voice code of one, two, or three digits. The voice code is generated at the source of goods 100 from the GTIN and lot code, and date if present, according to a particular algorithm that is shared with the distribution center 120. When a pallet 110 of cases 130 is received by the distribution center 120, a representative case label (or case labels, if the pallet 110 includes cases 130 from more than one lot) is read to create a record of the received GTIN and lot code and optional date combination. The voice code is again generated according to the algorithm, this time by the distribution center 120, using the shared algorithm. When an order for a GTIN is received from a retailer 160, a picker receives an instruction from the WMS to pick cases of the GTIN having the specific voice code. The picker can confirm the voice code to the WMS. It will be appreciated, therefore, that the picker does not have to employ a barcode reader, nor read a string of alphanumeric characters into a headset. It will be further appreciated that the present invention does not require the use of additional labeling of received pallets 110 by the distribution center 120.

The present invention also provides labels that comply with the PTI and that further include a prominent voice code of three, four, or five digits where two or three of the digits are more prominent than the remaining one or two digits, for example, by being larger. The more prominent digits are also referred to herein as primary digits while the less prominent digits are also referred to herein as secondary digits. In these further embodiments, the voice code is generated, applied, and used in much the same way as described above. Here, however, the secondary one or two digits are typically not used except in the occasional situation where the same two or three primary digits coincidentally appear on two different types of cases on the same pallet 110. Exemplary uses of voice codes comprising primary and secondary digits are provided below.

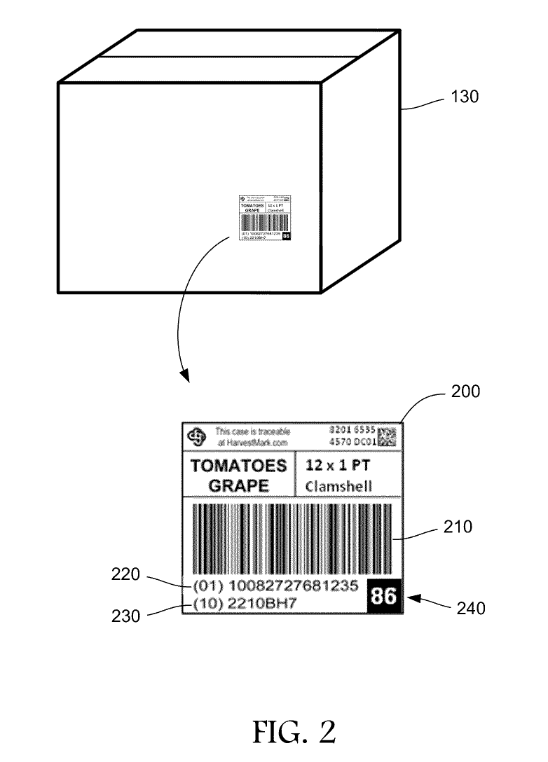

FIG. 2 provides a case 130 including an exemplary case label 200 of the present invention. The case label 200 complies with the PTI in that case label 200 includes a GTIN and a lot code in both a machine-readable format (the barcode 210) and a human-readable format (GTIN 220 and lot code 230, respectively). Note the date is not present in this example. The GTIN is a 14 digit numeric code while the lot code can be up to 20 alphanumeric characters. It will be understood that case label 200 is merely exemplary and labels for other containers commonly used to transport goods, such as trays, crates, sacks, RPCs, and bins, can also be made with a general code such as GTIN, a specific code such as the lot code, an optional date, and a voice code generated from the other codes.

The GTIN represents information about the contents of the case that is independent of the particular lot such as the brand name, type of product (e.g., grape tomatoes), quantity per unit, and so forth. The lot code, on the other hand, is associated with lot-specific information such as harvest event data like harvest date, harvest location, packing crew, and so forth. When the lot code is not date-specific, such as when it represents a plot of land, then a date code is also included. GTIN and lot codes are discussed in greater detail in U.S. patent application Ser. No. 12/176,334 filed on Jul. 19, 2008 and entitled “Case-Level Traceability Without the Need for Inline Printing,” U.S. patent application Ser. No. 12/414,123 filed on Mar. 30, 2009 and entitled “Parent Case Labels with Multiple Child Labels for Field Packed Produce,” and U.S. patent application Ser. No. 12/471,201 filed on May 22, 2009 and entitled “Case Labeling for Field-Packed Produce,” each of which is incorporated herein by reference.

The case label 200 optionally also includes one or more fields to identify the contents of the case 130. The case label 200 also optionally includes a unique serial number to uniquely identify the case 130 for further traceability purposes. In the FIG. 2 the unique serial number comprises 16 alphanumeric characters in both a human-readable format and a machine-readable format in the upper right corner of the case label 200. Such unique codes are discussed in greater detail in U.S. patent application Ser. No. 12/206,156 filed on Sep. 8, 2008 and entitled “Attributing Harvest Information with Unique Identifiers,” U.S. patent application Ser. No. 11/619,747 filed on Jan. 4, 2007 and entitled “System and Method of Code Generation and Authentication,” and U.S. patent application Ser. No. 11/347,424 filed on Feb. 2, 2006 and entitled “Method and System for Deterring Product Counterfeiting, Diversion and Piracy,” each of which is incorporated herein by reference.

The case label 200 further comprises a voice code 240. The voice code 240 is a numeric code of three or less digits derived from the GTIN and lot code, and date when present, by an algorithm. It is noted that the voice code 240 is not alphanumeric, but simply numeric, so as to exclude letters that are more likely to be misinterpreted by automated voice-recognition systems and can be misread or confused by an operator. While the voice code 240 can be three or less digits, two digits strikes a balance between ease of use (fewer digits for a picker to receive and repeat) and the total number of useful permutations. The voice code 240 is preferably printed in such a way as to make the voice code 240 stand out prominently on the case label 200, for example, by using a larger font size and/or white characters on a black background, as shown in FIG. 2.

The voice code 240 is generated from the GTIN and lot code and date when present with an algorithm at or before the time of printing. For example, the GTIN and lot code and date can be hashed with a hash function, such as MD5, with the output constrained to the desired domain (e.g., 2 digits) using a modulo function. Other exemplary implementations use a simple CRC (cyclic redundancy check), or another polynomial, to hash the GTIN and lot code and date, again with the output constrained to the desired domain using a modulo function. Still another exemplary implementation uses a modified Luhn/Regenstrief Institute algorithm to hash the GTIN and lot code and date. In some embodiments, the algorithm is configured to not produce certain values for the voice code 240, such as where both digits are the same, or where the first digit is zero.

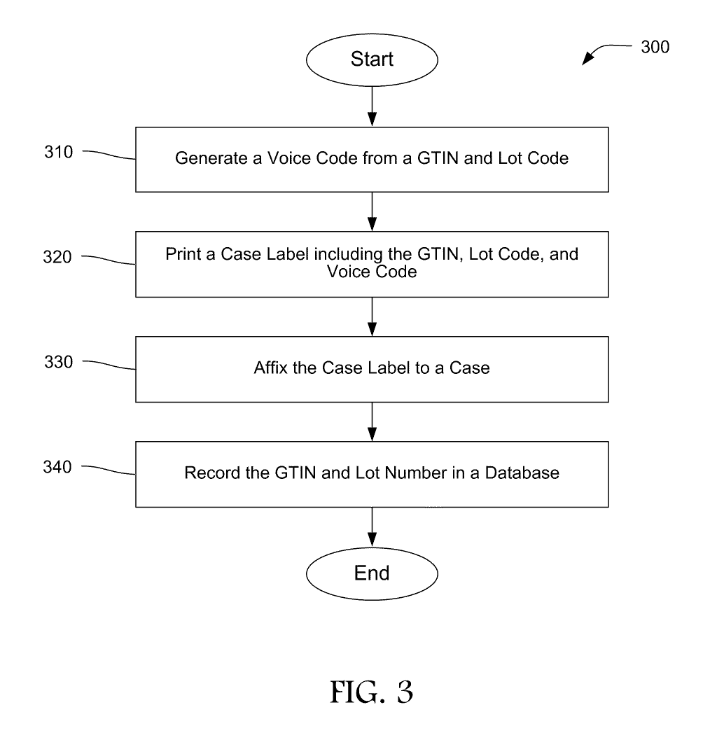

FIG. 3 illustrates an exemplary method 300 of the invention. The method 300 can be performed, for example, at a source of goods 100. The method 300 comprises a step 310 of generating a voice code 240 from a GTIN and lot code. As noted above, an algorithm is used to derive the voice code 240. In a step 320 a case label 200 is printed. The case label 200 includes the GTIN, lot code, and voice code 240. The case label 200 is then affixed to a case 130 in a step 330, for example, with an adhesive backing.

In a step 340 the GTIN and lot code are recorded in a database 140. Step 340 can also comprise recording other information in association with the GTIN and lot code such as the shipping time and date, a pallet identification, the intended destination, and so forth. The GTIN and lot code can be associated together and recorded at the time the voice code is generated, or at the time the case label 200 is printed, for example. Further information can be recorded in the database 140 in association with the GTIN and lot code as such information becomes available. In some embodiments, recording the additional information in association with the GTIN and lot code includes reading the GTIN and lot code with a barcode scanner from a case label 200 on a case 130 on a pallet 110.

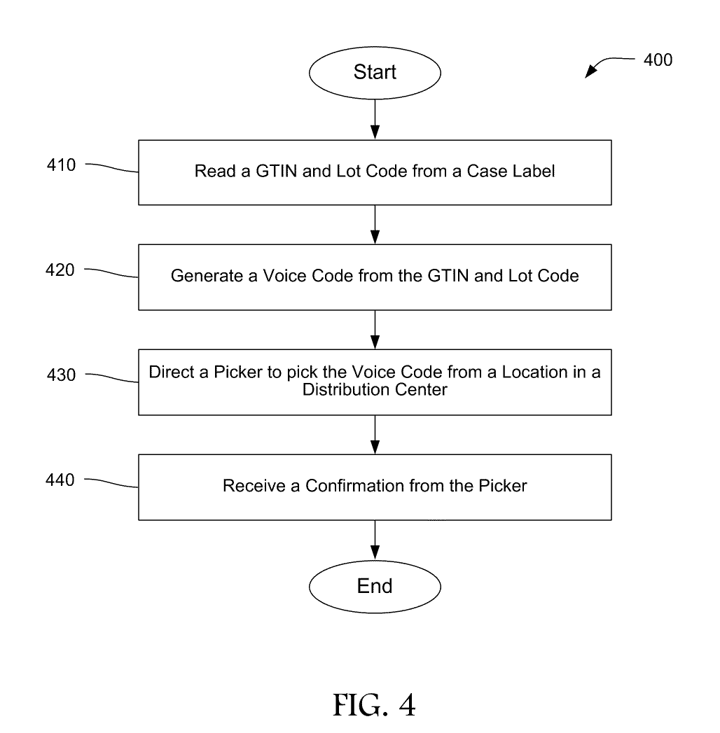

FIG. 4 illustrates another exemplary method 400 of the invention. The method 400 can be performed, for example, at a distribution center 120. The method 400 comprises a step 410 of reading a GTIN and lot code from a case label 200, for example, with a barcode scanner. The GTIN and lot code can be recorded in a database 150 and associated in the database 150 with other information such as the time and date of receipt. Addition of the GTIN and lot code to the database 150 can be achieved by scanning a hybrid pallet tag o the pallet 110, or by Advance Shipment Notice (ASN), in various embodiments.

In a step 420 the same algorithm used in step 310 of method 300 is used to generate the voice code 240 from the GTIN and lot code. Step 420 is performed, in some embodiments, by a WMS. Optionally, the voice code 240 is stored in association with the GTIN and lot code in the database 150 for later use, while in other embodiments the voice code 240 is generated upon receipt of an order for the particular GTIN.

When an order for a number of cases 130 of a GTIN is received by the distribution center 120 from a retailer 160, and the order calls for less than a full pallet 110 of cases 130, the WMS identifies a pallet 110 of cases 130 from which to pick the number of cases 130 to fill the order. In a step 430 a picker is directed to a location in the distribution center 120 where the identified pallet of cases 130 having the required GTIN resides. Further, in step 430 the picker is directed to pick a case with a particular voice code from that location.

More specifically, the WMS maintains records of the number of cases 130 for each particular GTIN, and also of the number of cases 130 associated with each different lot code and date when present associated with each GTIN. The WMS determines which lot code and date when present, if more than one exists, that the picker should pick from in order to fill the order, for example, to move oldest inventory first. In step 430 the WMS can either read the voice code 240 from the database 150 if the voice code has been previously generated in step 420, else the WMS can perform step 420 in response to receiving the order. The WMS then provides the picker with the location, voice code, and number of cases, for instance, through a headset. The WMS can additionally record in the database 150 the GTIN, lot code, optional date, and number of cases associated with the order. Additional information can also be recorded such as the picker identification, time that the order was filled, and so forth.

In an optional step 440 the WMS receives a confirmation from the picker. For example, the picker can repeat the voice code and/or number of cases 130 back to the WMS using the headset.

It will be appreciated that the method 400 can lead to situations where cases from different GTINs, lots or dates will have the same voice code 240. For instance, by coincidence two different lot codes hashed with the same GTIN will result in the same voice code 240. In some situations, one pallet 110 will be split such that some cases 130 are from a first lot code while some cases 130 are from a second lot code, and case labels 200 for both lots have the same voice code 240. It will be appreciated, however, that in many instances pallets 110 are homogeneous and all cases 130 have the same lot code and voice code 240. In those remaining instances where a pallet 110 is split between two or more lots, for a two digit voice code 240, there is only a small chance of a collision where the voice code 240 is not sufficient to differentiate the different lots.

The WMS can identify such potential collisions since the WMS has a record of all of the lot codes associated with each GTIN. In the event that a picker would be directed to a voice code 240 in a collision situation, the WMS can inform the picker to select cases 130 using an additional differentiator, such as the first or last character of the lot code.

Another situation that can arise when a pallet 110 is split between two lots is the situation where the picker is directed to select cases 130 with a particular voice code 240, and those cases 130 are found to be buried on the pallet 110 beneath cases 130 from the other lot. Here, the picker can pick the number of cases 130 from the accessible lot and inform the WMS of the voice code of the picked cases 130 via the headset. The WMS can then associate the correct lot code with the order and deplete inventory accordingly.

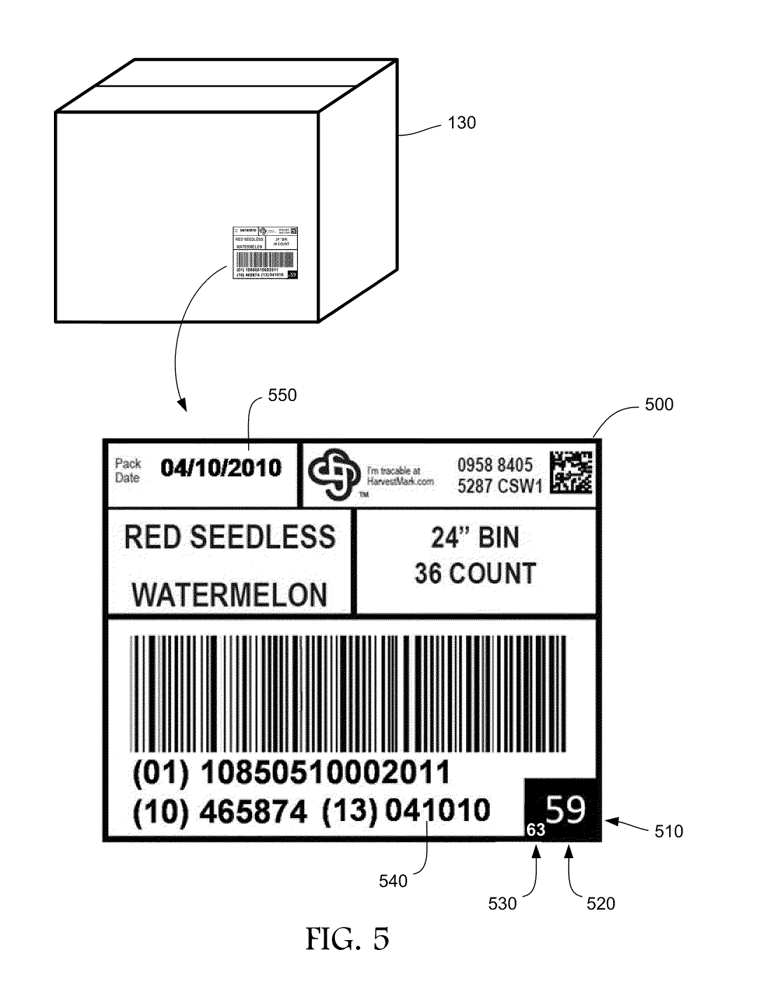

FIG. 5 provides a case 130 including another exemplary case label 500 of the present invention. It will be appreciated that the methods of the invention illustrated with reference to FIGS. 3 and 4 can utilize case label 500 in place of case label 200. Case label 500 complies with the PTI and comprises a prominent voice code 510 of three, four, or five digits. The three to five digits of the voice code 510 are divided into primary digits 520 and secondary digits 530. The primary digits 520 comprise two or three of the digits of the voice code 510 while the remaining one or two digits comprise the secondary digits 530. In the particular embodiment shown in FIG. 5 the voice code 510 comprises four digits, of which two digits are primary digits 520 and two are secondary digits 530. Primary digits 520 and secondary digits 530 are necessarily visually distinguishable with the primary digits 520 being more visually prominent than the secondary digits 530, in this embodiment by being printed with a larger font size. The digits 520, 530 can also be distinguishable from one another based on color, background color, font, placement, orientation, combinations thereof, etc. In the illustrated embodiment, the case label 500 also includes a date 540 a machine-readable format and the date 550 in a human-readable format.

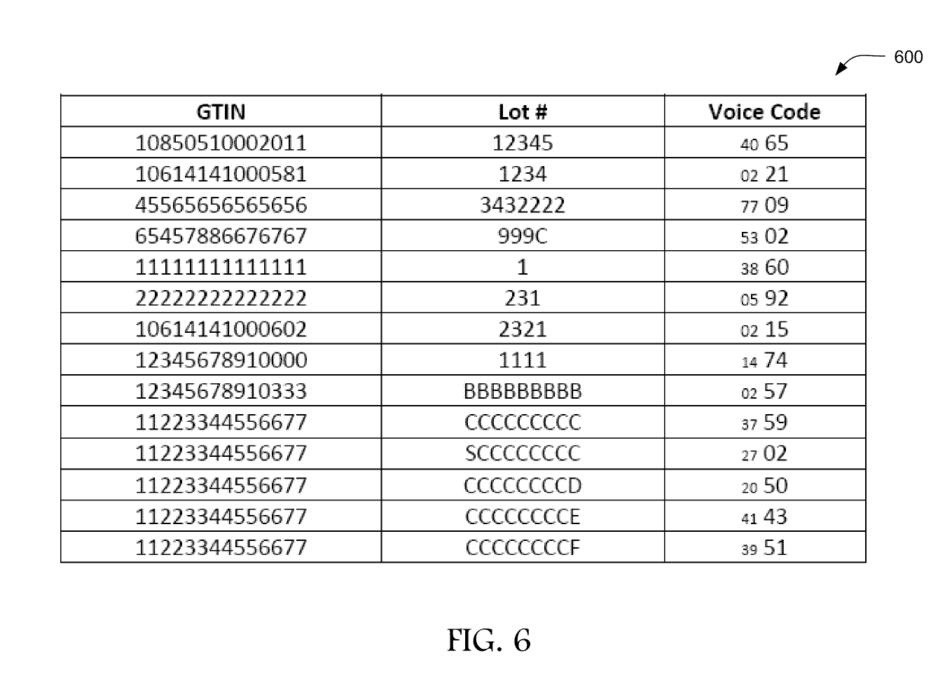

FIG. 6 provides a table 600 of exemplary four digit voice codes 510 comprising two primary digits 520 and two secondary digits 530. The exemplary voice codes 510 are generated from exemplary pairs of GTINs and lot codes. Successive pairs of GTINs and lot codes in the table 600 illustrate that sequential changes in either the GTIN or lot code do not lead to sequential changes in the voice codes 510 but rather lead to changes where most if not all of the digits are different. It will be appreciated that although the digits may appear random, and in some embodiments are random, randomness is not essential to the invention.

In FIG. 6 there would be a primary digit collision if a pallet 110 had cases 130 from both the 4^{th} and 11^{th} rows since both would have the same two primary digits 520, “02.” However, cases 130 can be readily differentiated by the secondary digits 530, which are different. A secondary digit collision occurs when both the primary and secondary digits 520, 530 are the same for cases 130 with different GTINs and/or lot codes on the same pallet 110.

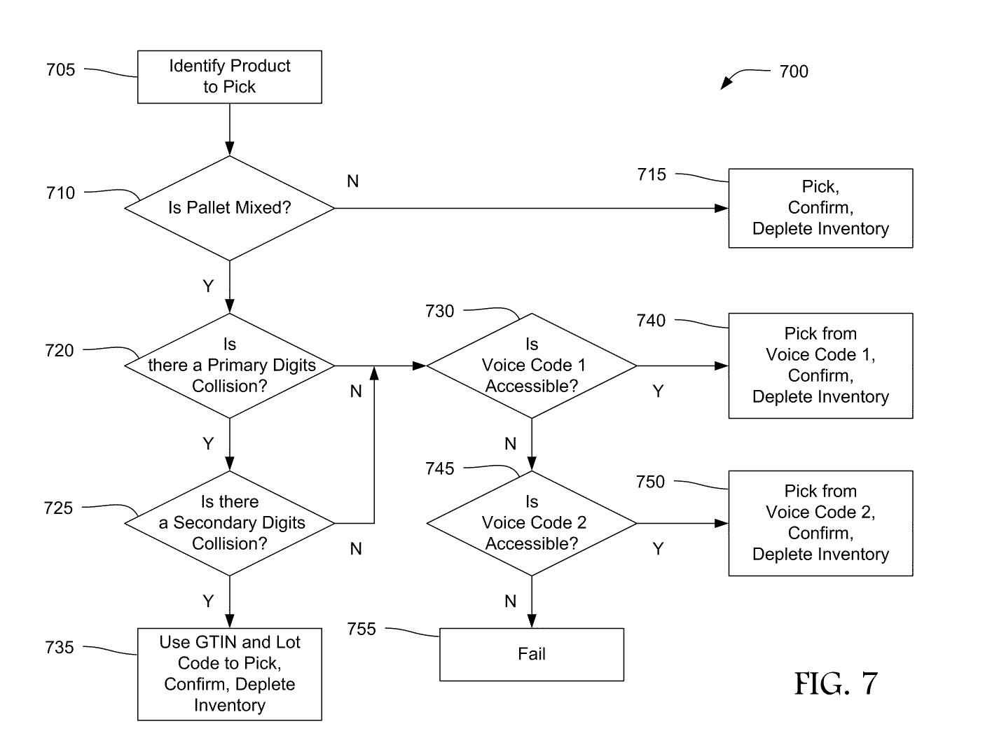

FIG. 7 is a flowchart representation of a method 700 for picking cases 130, for example, in a distribution center or warehouse. Steps of the method 700 can be performed, in some embodiments, by a computing system such as a server, workstation, or personal computer running a WMS. The WMS communicates with a picker by sending commands and receiving responses.

In a step 705 a product to be picked is identified. The identification of the product can include a quantity. For example, step 705 can include the WMS receiving an order, such as for 6 cases 130 of a particular product. Step 705 can then include selecting a pallet 110 known to have at least 6 cases 130 of the product, for instance. The selected pallet 110 may include only cases 130 of the desired product, or may be split between multiple types of products. In either instance, those cases 130 of the desired product may all share a common GTIN and lot code, or in some situations cases 130 may have the same GTIN but different lot codes. Regardless, the product to be picked has been identified at this point, even though a particular GTIN and lot code pair has not yet been specified. The WMS system tracks the locations of pallets 110, the GTIN and lot code pairs to be found on each pallet 110, and tracks the number of cases 130 for each GTIN and lot code pair. Thus, the WMS is able to identify the product to be picked by reference to stored pallet information. Where multiple pallets 110 each have a sufficient number of the desired cases 130, the WMS may make the selection according to rules that optimize stock rotation, for example.

In a step 710 a determination is made as to whether the pallet 110 is mixed, meaning that the cases 130 on the pallet 110 do not all share a common GTIN and lot code pair. The WMS is also able to make the determination in step 710 by reference to stored pallet information. Generally, most pallets 110 are not mixed. In the following, it will be assumed that 10% of all pallets 110 are mixed. Under this assumption, 90% of the time the step 710 results in a determination that the pallet 110 is not mixed. In these instances the identified product is picked in a step 715, otherwise, the method moves on to a step 720.

In step 715 the identified product is picked from a non-mixed pallet 110. This step can include the WMS sending instructions to a picker directing the picker to the pallet 110 at a specific location and directing the picker to pick the desired number of cases 130 having a voice code, where the voice code is simply the primary digits 520 that are generated from the GTIN and lot code that are common to all of the cases on that pallet 110. The step 715 can also include the picker going to the specified location, picking the desired number of cases 130, and sending a confirmation back to the WMS. The confirmation can include repeating the number of cases picked and reading the primary digits 520 from a case label 500 into a microphone. The confirmation can also include the WMS receiving the number and voice code from the picker and verifying that both match the sent instructions. The step 715 can further include the WMS depleting the inventory, in other words, updating a record for the pallet 110 of the remaining number of cases having the particular GTIN and lot code pair that was picked.

In the step 720, which occurs 10% of the time in the given example, the pallet 110 is mixed and a determination is made whether there is a primary digits collision, defined as a situation where the primary digits 520 for the desired GTIN and lot code pair is the same as the primary digits 520 for another GTIN and lot code pair on the same pallet 110. If there is a primary digits collision, the method 700 moves to a step 725, otherwise to a step 730. The WMS is also able to make the determination whether there is a primary digits collision in step 720 by referencing stored pallet information.

In step 725 a determination is made whether there is a secondary digits collision, defined as a situation where both the primary digits 520 and the secondary digits 530 for the desired GTIN and lot code pair is the same as those for another GTIN and lot code pair on the same pallet 110. The WMS is also able to make the determination whether there is a secondary digits collision by referencing stored pallet information. If voice codes 510 are determined by an algorithm that produces random codes, then step 725 will be invoked in 1% of the instances in which there are two primary digits 520 and a mixed pallet 110 with just two types of cases 130. Thus, for the given example, step 725 is invoked only once in about 1,000 times that method 700 is performed.

Since the odds of a secondary digits collision is also 1% when using two secondary digits 530, the odds of a pick encountering a situation where the determination is made in step 725 that there is a secondary digits collision is about one in 100,000. Where the determination is made in step 725 that there is not a secondary digits collision, the method moves to step 730, otherwise to a step 735.

In the step 730 another determination is made, this time as to whether a first voice code is present and accessible. Step 730 can include the WMS sending instructions to a picker, the instructions directing the picker to the pallet 110 at a specific location and directing the picker to pick the desired number of cases 130 having the primary digits 520 of the first voice code, where the first voice code is generated from a GTIN and lot code pair selected by the WMS. Where the pallet 110 is mixed and includes more than one product, and all of the cases of the identified product share a common GTIN and lot code pair, the first voice code is the only voice code on the pallet 110 that is available to the picker to fill the order and the determination defaults to “yes” and the method 700 proceeds to a step 740.

More commonly, the mixed pallet 110 includes cases 130 of only one product, but more than one GTIN and lot code pair. In these situations the cases having the first voice code selected by the WMS may be buried beneath cases having another voice code. Where this happens, the picker determines that the first voice code is not accessible and the method 700 progresses to step 745. Otherwise, the first voice code is accessible and method 700 can then move to step 740. In the less common situation where the picker cannot find the first voice code on the pallet 110 at the given location, the first voice code is not present and method 700 moves to step 745.

In step 745 yet another determination is made, this time as to whether a second voice code is present and accessible. The picker may find, in some instances where cases 130 of the first voice code are not present or inaccessible, that cases 130 of the same product having another voice code are accessible on the pallet 110. In these instances, the method 700 moves to step 750. Otherwise, the picker may find that there are no cases of the intended product on the pallet 110 in which case the method 700 progresses to step 755.

In step 755 a failure of the WMS has occurred in as much as the WMS associated cases 130 with a voice code with a pallet 110, and no such product exists on the pallet 110. These, and other unusual circumstances, are of little consequence to the various embodiments of the present invention.

Steps 740 and 750 are similar to step 715 in that each includes picking cases 130, confirming to the WMS, and depleting inventory, each as described above. In step 740, the cases 130 picked have the first voice code, whereas in step 750 cases 130 having the second voice code are picked. In either situation, most of the time the confirmation to the WMS will be the primary digits 520, except where there was a secondary digits collision in step 725. In these cases, the confirmation to the WMS can comprise sending both primary digits 520 and secondary digits 530 to the WMS. Steps 740 and 750 also differ as to inventory depletion. In step 740 the WMS depletes the inventory, for example, by updating a record for the remaining number of cases having the first voice code on the pallet 110 by subtracting the number of cases 130 picked. Similarly, in step 750 the WMS can deplete the inventory, for example, by updating a record for the remaining number of cases 130 having the second voice code on the pallet 110 by subtracting the number of cases 130 picked.

Returning to Step 735, this step is invoked in the situation where there are two GTIN and lot code pairs for the same product on a pallet 110 and both pairs coincidentally produce the same primary and secondary digits 520, 530 of the same voice code. Here, the picker is instructed by the WMS to select cases to fill the order using digits from the GTIN and/or lot code, for example, the last three digits of the lot code. Step 735 also comprises the steps of confirming the cases picked to the WMS, and depleting the inventory, each as previously described.

It should be noted that if the probability is about 1 in 100,000 of encountering a mixed pallet 110 with a secondary collision, this means that if a distribution center 120 handles 10 million pallets 110 per year, the distribution center 120 would reach step 735 only about 100 times each year. This is likely to be far less than the number of pallets 110 that will be handled per year that lack PTI compliant labels.

Some steps of the methods described herein can be performed, for example, through the use of hardware, such as application-specific integrated circuits (ASICs), specifically designed to perform the particular functions of the method. Various steps of the methods described herein can also be performed through the use of firmware residing, for instance, in read only memory (ROM) or flash memory, where the firmware is programmed to perform the particular functions of the method steps. Steps of the methods described herein can also be performed by a processor capable of executing software residing in a memory, for example, in random access memory (RAM), where the computer instructions embodied in the software define the method steps. Any combination of two or more of hardware, firmware, and software can also be employed. Hardware, firmware, and/or software for implementing method steps may be embodied in handheld scanners, for example. Hardware, firmware, and/or software for implementing method steps may also be embodied in various types of computing systems such as servers and personal computers. It will be appreciated that such computing systems, when configured to follow specific logic embodied in their circuits or programming instructions, or both, constitute specific machines.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A label comprising:
a GTIN and lot code both in a machine-readable format and in a human-readable format; and
a numeric code comprising at least three digits and no more than five digits,
the numeric code being derived from the GTIN and the lot code,
at least two of the digits of the numeric code being primary digits,
at least one of the digits of the numeric code being secondary digits,
wherein the primary and secondary digits are visually distinguishable.

2. The label of claim 1 wherein the numeric code comprises four digits including two primary digits and two secondary digits.

3. The label of claim 1 wherein the numeric code is printed as white numerals on a black background.

4. The label of claim 1 wherein the primary digits are printed with a larger font than the secondary digits.

5. The label of claim 1 further comprising a date, the numeric code being derived from the GTIN, the lot code, and the date.

6. A method comprising:
generating a numeric code of at least three digits and no more than five digits from a GTIN and a lot code using an algorithm;
affixing a label to a case, the label including the GTIN, lot code, and numeric code; and
recording the GTIN and lot code into a database.

7. The method of claim 6 wherein generating the numeric code using the algorithm comprises hashing the GTIN and lot code and constraining the output with a modulo function.

8. The method of claim 6 further comprising printing the label after generating the numeric code.

9. The method of claim 6 wherein the numeric code is generated, using the algorithm, from the GTIN, the lot code, and a date, and wherein the label further includes the date.

10. A method comprising:
reading a GTIN and a lot code from a label;
generating a numeric code of at least three digits and no more than five digits from the GTIN and the lot code using an algorithm, at least two of the digits of the numeric code being primary digits and at least one of the digits of the numeric code being secondary digits;
directing a picker to pick the primary digits from a location in a distribution center;
receiving a confirmation from the picker; and
associating the GTIN and lot code with an order.

11. The method of claim 10 further comprising reading a date from the label, wherein the numeric code is generated, using the algorithm, from the GTIN, the lot code, and the date.

12. The method of claim 10 wherein the confirmation comprises the primary digits.

13. The method of claim 10 wherein reading the GTIN and lot code from the label is performed with a barcode scanner.

14. A method comprising:
reading a first GTIN and a first lot code from a label;
generating a first numeric code of at least three digits and no more than five digits from the first GTIN and the first lot code using an algorithm, at least two of the digits of the first numeric code being primary digits and at least one of the digits of the first numeric code being secondary digits;
identifying a product to pick, the product being characterized by the first GTIN and the first lot code;
determining a primary digit collision for the product between cases of the product at a location in a distribution center bearing a first label including the first numeric code, and
cases of the product at the location bearing a second label including a second numeric code;
directing a picker to pick the primary and secondary digits of the first numeric code from the location; and
receiving a confirmation from the picker.

15. The method of claim 14 wherein the confirmation comprises the secondary digits of the first numeric code.

16. The method of claim 14 further comprising associating the first GTIN and the first lot code with an order.

17. The method of claim 14 wherein the confirmation comprises digits other than the secondary digits of the first numeric code.

18. The method of claim 17 further comprising
verifying that the confirmation matches secondary digits of the second numeric code, and
associating a second GTIN and a second lot code associated with the second label with an order.

19. The method of claim 14 further comprising reading a date from the label, wherein the first numeric code is generated, using the algorithm, from the GTIN, the lot code, and the date.
